(19) United States
(12) Patent Application Publication
(10) Pub. No.: US 2005/0253966 A1
(43) Pub. Date: Nov. 17, 2005

(54) System for processing video signals

(75) Inventor: Mark Mertens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., NL-5621 BA EINDHOVEN (NL)

(21) Appl. No.: 10/519,057

(22) PCT Filed: Jun. 19, 2003
(86) PCT No.: PCT/IB03/02854

§ 371 Date: Dec. 22, 2004

(30) Foreign Application Priority Data
Jul. 1, 2002 (EP) 02077606.8

(51) Int. Cl. H04N 9/74

(52) U.S. Cl. 348/553; 348/588

(57) ABSTRACT

The invention relates to a system for processing video signals, the system comprising a receiver (100) arranged to receive video signals, at least one video frame of which comprises at least one area corresponding to a respective one of a plurality of broadcast data sources. The system comprises a processor (150) arranged to process said video frames to extract at least a part of said area from at least one of said video frames. The frame (200) of a mosaic video signal may comprise one or more small pictures (210) and each of them may render a miniature version of a television program. A detection of edges and a detection of lines can be performed for extracting said area (210) or sub-area (240) from the frame. The television channel, from which the extracted area or sub-area was received or with which it is associated, can be identified. The user is enabled to specify a representation of the extracted area or sub-area on a display screen.

The invention relates to a system for processing video signals, the system comprising a receiver arranged to receive video signals, at least one video frame of which comprises at least one area corresponding to a respective one of a plurality of broadcast data sources.

U.S. Pat. No. 5,633,683 discloses a television receiver for receiving and displaying a mosaic video signal including a plurality of sub-pictures, each sub-picture representing one of a plurality of video signals, and position data linking a position of each sub-picture on a display screen with a program number of the associated video signal. The receiver comprises a decoder for decoding the program number of a video signal represented by the position of the sub-picture being displayed and pointed at by a user. Thus, the user can select a desired program for watching, recording etc by simply “pointing and clicking” the corresponding sub-picture on the mosaic screen. The receiver further comprises means for deriving the selected sub-picture from the mosaic signal and means for simultaneously displaying the selected sub-picture and the associated video signal for a predetermined period of time after selecting said video signal. In that way, the receiver comprises a first decoder for decoding and displaying the selected program and a further decoder for processing the mosaic video signal. The sub-picture being characteristic of the selected program is cut out and displayed as a picture-in-picture.

The sub-pictures can be derived only when the position data is obtained by the television receiver. Such an arrangement requires the special transmitter adapted to generate the position data, which is a limitation of using such a technique. For example, if the equipment of a television service provider cannot be arranged to generate the position data, the sub-pictures cannot be derived by the receiver.

It is an object of the invention to provide a system of the kind defined in the opening paragraph which can suitably operate with the video signal regardless of obtaining said position data linking the position of each sub-picture on the display screen with the program number of the associated video signal.

The object of the invention is realized in that the system comprises a processor being arranged to process said video frames to extract at least a part of said area from at least one of said video frames.

The frames received by the receiver comprise one or more areas corresponding to the respective broadcast source. For example, the frame comprises small pictures and each of them may render a miniature version of a television program broadcast on the respective television channel. Usually, the pictures have a rectangular form. The receiver comprises the processor arranged to graphically process video data of each frame and extract the complete picture from the frame. In another example, video information broadcast on one television channel occupies a whole or part of the area of the frame, and only part of said video information, sub-area or sub-picture is extracted by the processor. Said sub-area, e.g. a weather map or graph figure, may have the rectangular, circle, or any other shape forming a closed figure.

First, a detection of edges can be performed for retrieving said area or sub-area from the frame by the processor. Thus, edges between areas or edges between a sub-area and other video data are determined. In one of the embodiments, the detection of edges is performed on a plurality of sequential frames, e.g. by using a temporal filter, where a position of the area or sub-area is the same on these frames. The detection of edges is more reliable when the processor analyses more than one frame to determine edges of the area on the frame. Therefore, the edges between areas within the frame or the edges between sub-areas within the area are made stronger than other edges which exist in the frame and change over time, e.g. due to the motion of objects, characters, in it. The detection can be improved by further performing a detection of lines delimiting the area or sub-area from the other video data, e.g. a Hough transform can be used for such a detection. In the case of the mosaic frame, a property that lines between pictures are equidistant may be used during the extraction process to reduce or avoid possible spurious detection. When horizontal and vertical lines for the correspondent area or sub-area are determined, the video data of that area or sub-area may be further processed and/or transferred to a presentation means such as a display device for showing the extracted information. It is an advantage of the system according to the present invention that no data indicating the position of areas in the frames are needed. This gives a possibility to extract the video information independently of what auxiliary data for processing the information are available, without unnecessary restrictions given in the prior art.

Alternatively, the receiver comprises a marker with which a user can indicate the area or sub-area of the frame shown by the presentation means, which is to be extracted from at least one of the video frames. The processor need not determine said area or sub-area by using the detection of edges and lines because the area or sub-area to be extracted is readily specified by the user. In other words, the user may be enabled to mark some part of the frame or frames shown on a screen, and that area or sub-area will be extracted from one or more frames. It is another advantage that the present invention provides more ways of processing the video information than is known in the prior art.

In one of the embodiments, the receiver further comprises means for identifying the broadcast data source, or a television channel, from which the extracted area or sub-area was received or with which it is associated. When the area or sub-area is extracted, it may be presented as video data without any knowledge of what happens with these data next. If the area or sub-area were extracted from the mosaic video signal, it might be unknown to which channel they correspond. There are many ways of identifying the respective channel. For example, a logo of the TV channel may be present in the extracted area or area from which the sub-area was extracted. The user may also specify the channel manually.

In another embodiment, the presentation means may enable the user to specify a representation of the extracted area or sub-area on the screen. For example, a position of the extracted information may be fitted to the user's preferences, the screen area in which the extracted area or sub-area is shown may be modified, etc.

These and other aspects of the invention will be further elucidated and described with reference to the accompanying drawings, wherein:

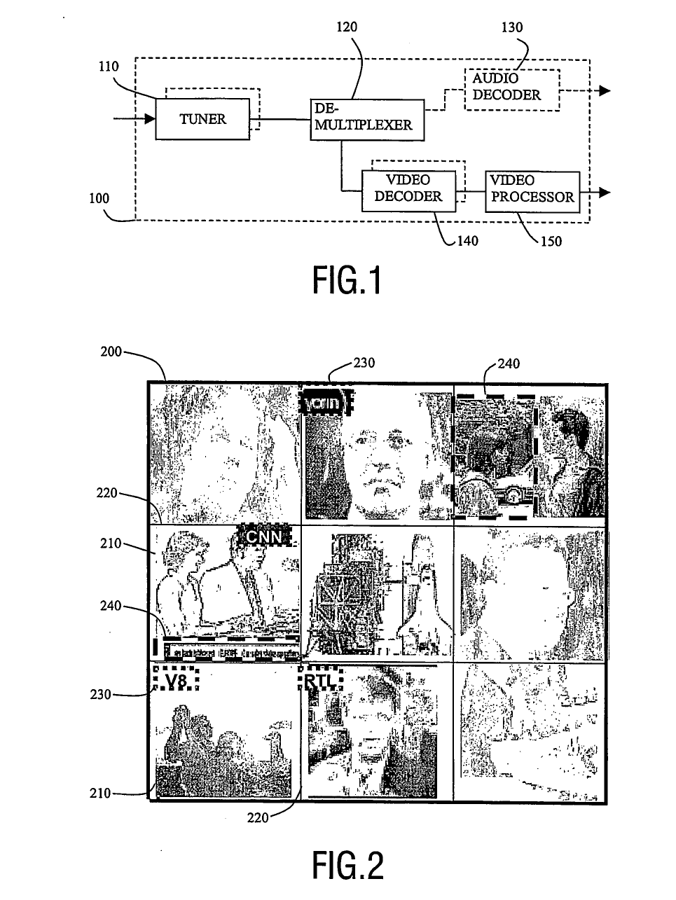

FIG. 1 shows a functional block diagram of the receiver of the system suitable for implementing the present invention;

FIG. 2 shows a visual presentation according to an embodiment of the present invention, in which the mosaic screen is shown;

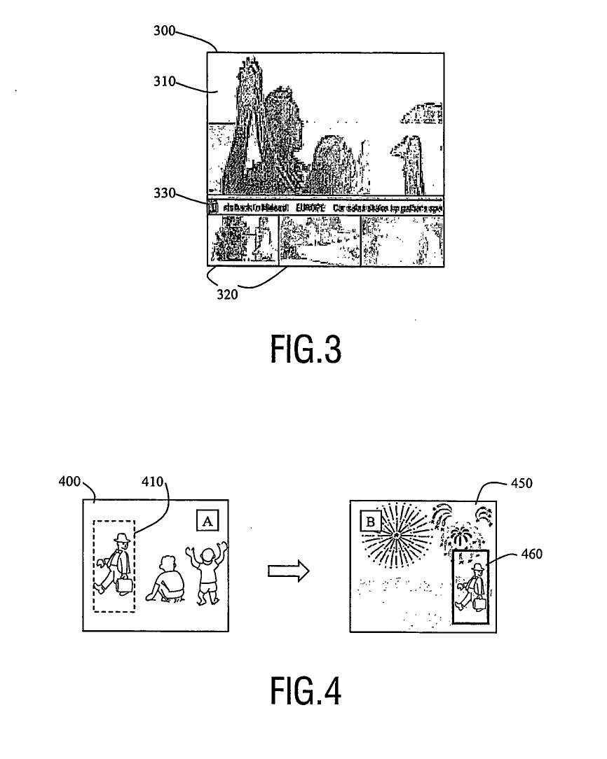

FIG. 3 shows an example of a visual presentation according to an embodiment of the present invention, in which the sub-area extracted from the mosaic screen is shown in a subsidiary screen area, whereas the areas extracted from the mosaic screen are shown in other subsidiary screen areas;

FIG. 4 shows an example of extracting the sub-area corresponding to one broadcast data source to be shown simultaneously with the frames corresponding to another broadcast data source.

FIG. 1 is a functional block diagram of a receiver according to the present invention. The system comprises a receiver 100 which may be connected to or comprise a display device (not shown), and VCR (Video Cassette Recorder), loudspeakers or other devices. The receiver may also be integrated into different devices such as set-top boxes or other devices designed for operating with AV (audio-video) signals. The receiver 100 receives a plurality of video signals transmitted via a satellite, terrestrial, cable or other link. A command can be inputted to the receiver by an infrared signal transmitted from a remote control unit (not shown). Thus, the receiver comprises a receiver (not shown) operating with control signals. The remote control unit may have special buttons associated with possible commands for controlling the receiver as it is described herein. Nowadays, MPEG-based systems for transmitting and/or receiving digital video signals are well known. The receiver according to the present invention may be arranged to receive digital and/or analog video signals.

The receiver comprises at least one tuner 110, a demultiplexer 120, an optional audio decoder 130, at least one video decoder 140 and a video processor 150. The received video signals are applied to the tuner 110.

The video signals may incorporate a mosaic video signal comprising frames with small-size pictures occupying a relatively small area of the respective frame. Each picture represents video signals associated with the respective TV channel, Internet broadcasting center or other broadcast data source. Alternatively, the video signals may comprise information received from a single broadcast data source. For example, the tuner may receive video signals of only one TV channel.

The tuner 110 may include demodulation circuits for demodulation of the received signal and error correction circuits for detecting and correcting any occurred error. The output of the tuner is supplied to the demultiplexer 120 for deciphering the signal. The demultiplexer provides the output audio signal to the audio decoder 130 and output video signal to the video decoder 140. The decoders 130 and 140 decode the audio and video signal, respectively, which may be a MPEG-compressed signal. With the future development of video systems, the implementation of the present invention may be varied by the person skilled in the art.

The receiver may comprise more than one tuner and more than one decoder, for example two tuners and two video decoders. Each decoder may comprise a memory (not shown) for storing the video signal. One of the tuners may be used to receive signals of a user-selected channel, while another tuner is used to receive the video mosaic signals. In that way, one of the video decoders may be used for decoding the video mosaic signals. The signals corresponding to the different TV channels are received with the mosaic video signal. It is an advantage of the present invention that, alternatively, the receiver may comprise only one tuner and perform the same functions as when two tuners are available. For example, the tuner may be arranged to receive the signals of the channel selected by the user, and receive the signals of the mosaic. The single tuner may tune to e.g. the mosaic channel for x, e.g. 3, pictures and to the main, e.g. user-selected, program for 50-x pictures. The x picture period leaves the tuner enough time to extract at least one picture from the mosaic channel. The missing pictures for the main channel can be created by picture repetition, or in a high-end system with a natural motion interpolation. Because only a few pictures are missing from the main program, this is hardly visible to a viewer.

The decoder 140 supplies the decoded video signal to the video processor 150. The processor processes the received signal according to the present invention to extract video information.

When the mosaic video signal is found to be available, the frames of said signal are simple pictures, or video information, which are analyzed without any additional data. FIG. 2 shows an example of a frame 200 of the mosaic video signal. To identify areas 210, coordinates XY of the corresponding area, usually having a rectangular or rectangular-like form, on the frame have to be determined. This can be done first by using a detection of edge technique generally known from the book “Two-dimensional signal and image processing”, Jae S. Lim, Prentice-Hall PTR, New Jersey, 1990, pp. 476-483. The edges between areas 210 corresponding to different TV channels have to be detected. The edge is a boundary or contour at which changes in physical aspects of the image occur, for example changes in pixel gray value, color and texture. Where the physical aspects change rapidly, an edge line from a strip of candidate edge points is determined according to the algorithm described in the above reference. For example, a threshold value for the physical parameter can be determined by computing the gradient of vectors in the x- and y-direction. A magnitude of the gradient is then compared with the threshold to determine candidate edge points. After that the edges will appear as strips, and e.g. an edge thinning algorithm is applied to determine an edge curve. In one simple edge thinning algorithm, the edge points are selected by checking if a module of the gradient is a local maximum in at least one direction. The detection of edges may be performed on the sequential frames for the same area to ensure the correct detection.

A detection of lines 220 is performed by the processor 150 after the detection of edges. Many methods for finding an alignment of points in the image and arrangement of features are known. For example, a so-called “least features” method where a sum of squares of vertical deviations of each point from the line is minimized can be used to fit a straight line to data points. A superior Hough method may advantageously be used as it is known from “The image processing handbook”, John C. Russ, CRC Press, Boca Raton, Fla., 1995, pp. 495-500. It should be noted that said method can also be used for detecting areas bordered by non-straight lines in the frame. When a fit of a line to the detected edges is determined, the necessary video area is known to the system. If the area has the rectangular form, coordinates XY of the area on the frame are determined, while the video data corresponding to the area can be identified and separated from video data of the complete frame.

When the area 210 corresponding to the respective broadcast data source, or TV channel, is extracted, there may still remain an uncertainty to which TV channel the area corresponds, or it may be simply unknown to the system from the received frames, or simple images. For this purpose, the processor 150 may be further arranged to identify the source of the extracted video area. One of the possibilities is that the processor analyzes the entire area 210 for locating a logo 230 of the TV channel, if it is available. Then, a recognition technique known in the prior art is applied to recognize a sign, logo-image, text, etc. which is then compared with identification information of the channels, previously determined by the system or predetermined by the manufacturer, stored in the receiver.

Alternatively, in a phase of determining the location of a logo, the user may “manually” highlight the logo video area on the screen. A temporal analysis may be applied for the logo video data, e.g. by detecting it in the sequential frames, over the number of frames. The logo data can be identified by using the detection technique described above, extracted and stored in the memory coupled to the processor. Logo identification data, a logo template, obtained in such a way may be used for identifying the TV channel. To identify the channel, the logo in the video signals may be correlated, e.g. using the well-known least squares method, with the logo template stored in the memory.

It may happen that the logo is not present in the frames when a commercial occurs. However, positioning of the area with information broadcast on the specific TV channel usually does not change with every next frame. This problem may be resolved by storing, in a memory means (not shown) coupled to the processor, a table of the TV channel identificators associated with the respective areas, as it is shown for the mosaic frame of FIG. 2 in Table 1. This table may be derived once by the system itself and stored.

TABLE 1

| SBS-6 | Yorin | Ned1 |
|---|---|---|
| CNN | BBC | RTL4 |
| V8 | RTL5 | Ned2 |

Alternatively, audio information corresponding to the image the TV channel of which is being established may be analyzed. Some TV channels periodically repeat broadcasting their own promotional pause, and accompany video information with a specific music. All of this may also be used for identifying the TV channel and implemented by the skilled person without difficulties.

In a further example, data for identification of the broadcast sources may be received from the remote transmitter. For example, a sequence of channel names (ID) or abbreviations received by the receiver 100 is sufficient for this purpose. Said data may comprise one special character (SC) specifying that a right, or other direction should be used for associating the identifier with the next area. In this way, only little additional information is needed. An example of such identification data for the mosaic frame of FIG. 2 is shown in the following Table 2. Implementation issues of such an identification method can be found in U.S. Pat. No. 5,633,683.

TABLE 2

| SC | ID | | | | | | | | |
|---|---|---|---|---|---|---|---|---|---|
| [symbol] | SBS-6 | Yorin | Ned1 | CNN | BBC | RTL4 | V8 | RTL5 | Ned2 |

According to a further aspect of the present invention, the processor 150 is arranged to extract only part of the area 240, or sub-area, corresponding to the respective broadcast data source, or TV channel. Such a sub-area may be extracted when position data for identification of the sub-areas in the area are generated by a transmitter, or broadcast data source, to the receiver and used by the processor. For example, the TV channel broadcaster may include such data in the digital video signal. A provider of mosaic video signals may incorporate that data in the mosaic signals for areas corresponding to the respective TV channel, if available. Such a system comprising the transmitter and receiver may be realized by the appropriate modification of the system known from U.S. Pat. No. 5,633,683.

Alternatively, the user can specify the sub-area to be extracted. For example, a cursor, marker or other pointer indicated on the frame 200, which is shown on the display device, can be used for such purposes. The user can use direction keys of the remote control unit to displace the marker, a cursor, and special keys for marking the sub-area 240 on the frame. When the sub-area is user-operably selected, the sub-area can be extracted from the next frames of the mosaic video signal.

It should be noted that if the user manually selects the whole rectangular area 210, the selected area corresponds to the rectangular area automatically detected, using the described technique, for example the Hough transform.

Another way of extracting sub-areas may be related to MPEG-4 standard providing possibilities of manipulation with video objects. Other ways may be derived within the scope of the present invention. The identification, if necessary, of the TV channel corresponding to the extracted sub-area may be performed as is disclosed above.

FIG. 4 shows a frame 400 of video signals of the TV channel. In contrast to examples stated above, all information in this frame corresponds to the same channel “A”. The sub-area 410 can be extracted in one of the manners disclosed with reference to the mosaic frame.

An identification of objects, such as people, an animal, a character, car, etc, within the areas may be performed by using the technique described above. The user may choose one or more of the identified objects to be further identified in the subsequent frames. Of course, if the object is a three-dimensional graphical figure, a presentation of the object may change over time. Therefore, an analysis of presence of the same object in different frames can be implemented. For example, in an MPEG-4 standard, a control of a video object is known, said video object may be matched with the objects shown in the next frames. The image of selected object extracted from the frame can be further displayed or processed. A set of the extracted object images corresponding to the specified object may also be stored for further display, or the like.

Generally, two types of extraction according to the present invention can be summarized. In the first case, the area or sub-area is extracted with respect to the position and size of that area or sub-area on the frame and independently of what is the content of that area or sub-area. In another case, the processor extracts the objects provided in the area and this object may be extracted from any part of the area wherein it is physically present.

It should be noted that the mosaic frames need not necessarily be received from broadcast TV signals. The receiver may comprise communication means for receiving, and may also be transmitting, digital video and audio content from the Internet.

The extracted video information can be further used for displaying it in many manners. The video processor may comprise a picture-in-picture processor (P-in-P) (not shown) or video switch functioning as it is known from U.S. Pat. No. 5,633,683, respectively. The extracted video information is further applied to the video switch. The video processor 150 can be suitably programmed to perform all functions disclosed herein. The audio and video output of the receiver 100 is further provided to AV devices for rendering audio and/or video content.

FIG. 3 shows an example of frame 300 presenting the extracted information. On frame 300, a main screen 310 wherein a program selected by the user or in other ways is shown. Subsidiary screens 320 are smaller than the main screen 310, for example, because the user does not like TV programs shown in the subsidiary screens so much as the program in the main screen. Video content shown in the subsidiary screens provides the user with information being broadcast on different TV channels and can be extracted as it is disclosed above, for instance, from the mosaic video signals. A frequency of refreshing the information in the subsidiary screens should be sufficient to keep the user sufficiently informed, for example, one frame of the respective TV channel per second or one frame every half second is shown. The frequency depends greatly on many factors such as number of tuners 110 available in the receiver 100, processing power of the processor 150, type of information provided to the receiver etc. It is also possible that “live”, real-time, video content is shown in the main and subsidiary screens.

The extracted sub-area may be shown in the same subsidiary screens as the extracted areas. Both extracted areas and sub-areas may be scaled, or mapped, to an area on the display screen predetermined by the user or system. As an example, a CNN “ticker tape” with “moving text” of news is extracted from the mosaic 240 and shown in the subsidiary screen 330.

The user may be enabled to change an arrangement of the subsidiary screens 320 in frame 300. A position of the subsidiary screen may be changed and the screen can be moved within the frame area. For example, the user would like to have the screen 330 at the upper side of the frame 300. For this purpose, the remote control unit may have a special button for switching the TV set to an editor mode. A display menu with commands for creating a new subsidiary screen, deleting, moving, changing a size, etc. of the subsidiary and/or main screen may be used in the editor mode. The user may also indicate the source of information to be shown in the respective screen 310, 320 or 330, the frequency of its renewal or other parameters. The user may be enabled to select an arrangement in which the extracted areas or sub-areas are scrolled sequentially through the subsidiary screen areas. A border, rim of the subsidiary area can be made bold, highlighted, etc. The results of editing the arrangement of frame 300 are further transferred to the video processor for controlling the extraction and adequate presentation of video content.

Another example of displaying extracted information is shown in FIG. 4. The sub-area 410 is selected for extraction from frame 400 of the TV channel “A”. The sub-area 410 is shown on frame 450 and scaled to the subsidiary area 460 having an arrangement with a black border. The image in screen 460 can be shown in scaled or semi-transparent form and distinguished by the black border from another TV program of channel “B” shown on the rest of the screen. Thus, the user may watch the content from two channels A and B.

In one of the embodiments, a data retrieving system comprises the receiver according to the present invention. Some of the areas or sub-areas may be stored in the memory with descriptions of their content. For example, the “ticker tape” 240 may be identified in the system with some descriptors such as “CNN news headlines”, “news banner”, etc. Generally, it can be done for TV programs in which such sub-areas are permanently present. The position of such sub-areas in the frames can be stored together with said descriptions. The user may also give pseudo-names to the sub-areas. A search interface for retrieving a desired sub-area on the display may be enabled upon the user's request. Thus, whenever the user would like to watch such a sub-area on the screen, he/she may easily retrieve it.

Other implementations, which provide similar functions, could be substituted for the aforementioned implementations without departing from the scope of the present invention. The various program products may implement the functions of the system and method of the present invention and may be combined in several ways with the hardware or located in different devices. Variations and modifications of the described embodiment are possible within the scope of the inventive concept.

1. A system for processing video signals, the system comprising a receiver arranged to receive video signals, at least one video frame of which comprises at least one area corresponding to a respective one of a plurality of broadcast data sources, characterized in that the system comprises
a processor being arranged to process said video frames to extract at least a part of said area from at least one of said video frames, by using an image analysis algorithm.

2. The system of claim 1, wherein said area or part of said area has a rectangular form.

3. The system of claim 1, wherein the processor is arranged to perform a detection of edges on said area or part of said area.

4. The system of claim 3, wherein the processor is further arranged to perform a detection of lines delimiting said area or part of said area from the respective frame.

5. The system of claim 3, wherein the processor is further arranged to perform the detection of edges on a plurality of sequential frames for the area or part of the area corresponding to the same one of data sources.

6. The system of claim 1, further comprising a marker for user-operably indicating said area or part of said area to be extracted from at least one of said video frames.

7. The system of claim 1, further comprising identification means for identifying a correspondence of the extracted area or part of the area to one of the plurality of broadcast data sources.

8. The system of claim 1, further comprising a presentation means being arranged to show at least one extracted area or part of the area mapped to a respective screen area.

9. The system of claim 1, wherein said system is operable to switch between reception of the video frames comprising at least one area corresponding to the respective one of the plurality of broadcast data sources and reception of video frames from a selected one of the broadcast data sources,
the presentation means being arranged to show, on a main screen area, said received video frames of the selected broadcast data source and, on at least one of a plurality of subsidiary screen areas, at least one extracted area or part of the area.

10. The system of claim 1, comprising a further receiver being arranged to receive video frames of video signals from a selected one of the broadcast data sources,
the presentation means being arranged to present, on a main screen area, said video frames of the selected broadcast data source received by the further receiver and, on at least one of a plurality of subsidiary screen areas, at least one extracted area or part of the area.

11. The system of claim 9, wherein said presentation means are arranged to user-operably specify a representation of at least one extracted area or part of area the in the respective one of the plurality of subsidiary screen areas.

12. The system of claim 11, wherein said presentation means are arranged to enable the user to specify a size and/or a position of at least one subsidiary screen area.

13. A receiver arranged to receive video signals, at least one video frame of which comprises at least one area corresponding to a respective one of a plurality of broadcast data sources, characterized in that the receiver comprises a processor being arranged to process said video frames to extract at least a part of said area from at least one of said video frames.

14. A computer program product enabling a programmable device, when executing said computer program product, to function as the system as defined in claim 1.
